(19) United States
(12) Patent Application Publication
(10) Pub. No.: US 2018/0011527 A1
(43) Pub. Date: Jan. 11, 2018

(54) MEMORY SYSTEM AND OPERATING METHOD THEREOF

(71) Applicant: SK hynix Inc., Gyeonggi-do (KR)

(72) Inventor: Hyoun-Ju KIM, Gyeonggi-do (KR)

(21) Appl. No.: 15/434,354

(22) Filed: Feb. 16, 2017

(30) Foreign Application Priority Data
Jul. 8, 2016 (KR) 10-2016-0086943

(51) Int. Cl. G06F 1/32; G06F 3/06

(52) U.S. Cl. CPC G06F 1/3275; G06F 3/0679; G06F 3/0659; G06F 3/0614; G06F 3/0647; G06F 3/0625; G06F 3/065

(57) ABSTRACT

A memory system includes: a memory device including a plurality of memory blocks configured to store data; and a controller configured to determine a power level for an operation corresponding to a command received from a host, and provide the determined power level to a memory block which is subject to the operation.

### CROSS-REFERENCE TO RELATED APPLICATION

This application claims priority under 35 U.S.C. §119(a) to Korean Patent Application No. 10-2016-0086943 filed on Jul. 8, 2016 in the Korean Intellectual Property Office, the disclosure of which is incorporated herein by reference in its entirety.

### TECHNICAL FIELD

Exemplary embodiments relate to a memory system which processes data to and from a memory device, and an operating method thereof.

### DISCUSSION OF THE RELATED ART

The computer environment paradigm has changed to ubiquitous computing systems that can be used anytime and anywhere. Due to this fact use of portable electronic devices such as mobile phones, digital cameras, and notebook computers has rapidly increased. These portable electronic devices generally use a memory system having one or more memory devices for storing data. The memory system may be used as a main memory device or an auxiliary memory device of a portable electronic device.

Memory systems using memory devices provide excellent stability, durability, high information access speed, and low power consumption, since they have no moving parts. Examples of memory systems having such advantages include universal serial bus (USB) memory devices, memory cards having various interfaces, and solid state drives (SSD).

### SUMMARY

Various embodiments are directed to an improved memory system capable of processing data to and from a memory device included in the memory system and a method of operating thereof. The memory system may determine and provide optimal power levels for operations to be performed to on the memory device so that the command operations can be more performed more reliably and the overall power consumption can be reduced.

In an embodiment, a memory system may include: a memory device including a plurality of memory blocks configured to store data; and a controller configured to determine a power level for an operation corresponding to a command received from a host, and provide the determined power level to a memory block which is subject to the operation.

The controller may determine the power level for the operation corresponding to the command by checking at least one operation parameter of the operation included in the received command.

The at least one operation parameter of the operation may indicate whether the operation to be performed is a one-shot program/read, a multi-plane program/read, and a one-plane program/read.

The at least one operation parameter of the operation may indicate at least one of a reliability value and an importance value of the operation.

The at least one operation parameter of the operation may indicate at least one of a priority, a size and a type of data subject to the operation.

The priority of the data may be determined according to an importance value of the data and a reliability of process to the data.

The type of the data may include at least one of: i) a metadata or user data, ii) a random data or sequential data, iii) a hot data or cold data, iv) a temporary data or short term data or long term data, v) a real-time data or a non-real-time data vi) a text data or audio data or image data or video data, and vii) an operating system (OS) data or a firmware data.

The at least one operation parameter of the operation may indicate at least one of a single level cell memory block, and a multiple level cell memory block.

The controller may further determine the power level for a background operation at least including a data copy operation and a data swap operation.

The controller may determine the power level for the background operation by checking an operation parameter of the background operation, and The operation parameter of the background operation may indicate at least one of: i) a one-shot program/read, a multi-plane program/read, and a one-plane program/read; ii) reliability and importance values of the background operation; and iii) a priority, a size and a type of data subject to the background operation.

In an embodiment, an operating method of a memory system including a plurality of memory blocks, the operating method may include: receiving a command from a host; determining a power level for an operation corresponding to the command; and providing the determined power level to one of the memory blocks subject to the operation.

The power level for the operation corresponding to the command may be determined by checking an operation parameter of the operation.

The operation parameter of the operation may indicate at least one of a one-shot program/read, a multi-plane program/read, and a one-plane program/read.

The operation parameter of the operation may indicate at least one of a reliability and an importance value of the operation.

The operation parameters of the operation may indicate at least one of a priority, a size and a type of data subject to the operation.

The priority of the data may be determined according to the importance value of the data and reliability of process to the data.

The type of the data may include at least one of: i) metadata or user data, ii) random data or sequential data, iii) hot data or cold data, iv) temporary data or short term data or long term data, v) real-time data or non-real-time data, vi) text data or audio data, viii) image data or video data and ix) operating system (OS) data or firmware data.

The operation parameter of the operation may indicate at least one of a single level cell memory block, and a multiple level cell memory block.

The operating method may further include determining the power level for a background operation at least including a data copy operation and a data swap operation.

The power level for the background operation may be determined by checking an operation parameter of the background operation, and the operation parameter of the background operation may indicate at least one of: i) a one-shot program/read, a multi-plane program/read, and a one-plane program/read; ii) reliability and importance values of the background operation, and iii) a priority, a size and a type of data subject to the background operation.

In an embodiment, a memory system may include: a plurality of pages having a plurality of memory cells coupled to a plurality of corresponding word lines for storing data; a plurality of memory blocks including the pages; a plurality of planes including the memory blocks; a plurality of memory dies including the planes; and a controller configured to check a command operation corresponding to a command provided from a host, check among the memory blocks a first memory block, a second memory block and a third memory block that perform the command operation, set a first power level for the first memory block, a second power level for the second memory block, and a third power level for the third memory block, and provide powers corresponding to the respective power levels to the first memory block, the second memory block and the third memory block.

Each of the power levels may be determined based on an operation parameter when the command operation is performed in each of the first memory block, the second memory block and the third memory block.

The operation parameter may be determined in correspondence with a type and a pattern of the command operation in the first memory block, the second memory block and the third memory block.

The operation parameter may be determined in correspondence with a reliability and an importance value of the command operation in the first memory block, the second memory block and the third memory block.

The operation parameter may be determined in correspondence with at least one among a priority, a size and a type of data corresponding to the command operation in the first memory block, the second memory block and the third memory block.

The priority of the data may be determined in correspondence with an importance value of the data and a reliability of data processing.

The type of the data may be determined in correspondence with at least one among characteristics of the data, a locality of the data, a processing pattern of the data, a processing latency of the data, and a frequency, the number of times or aging of the command operation for the data.

The operation parameter may be determined in correspondence with a memory cell type of each of the first memory block, the second memory block and the third memory block, and wherein the first memory block, the second memory block and the third memory block may be included in respective different memory dies.

The controller may set the respective power levels in the case where a data copy operation or a data swap operation is performed in each of the first memory block, the second memory block and the third memory block.

Each of respective power levels may be determined in correspondence with at least one among a type, a pattern, a reliability and an importance value of the data copy operation or the data swap operation, and a priority, a size and a type of data corresponding to the data copy operation or the data swap operation.

### BRIEF DESCRIPTION OF THE DRAWINGS

These and other features and advantages of the present invention will be described in detail in reference to the accompanying drawings, wherein:

FIG. 1 is a diagram illustrating a data processing system including a memory system, according to an embodiment of the present invention.

FIG. 2 is a diagram illustrating an exemplary configuration of a memory device employed in the memory system of FIG. 1.

FIG. 3 is a circuit diagram illustrating an exemplary configuration of a memory block in the memory device of FIG. 2.

FIG. 4 is a diagram schematically illustrating a three-dimensional configuration of the memory device of FIG. 2.

FIGS. 5 and 6 are diagrams schematically illustrating an example of a data processing operation with respect to a memory device in a memory system, in accordance with an embodiment of the present invention.

FIG. 7 is a flowchart illustrating a data processing operation, in accordance with an embodiment of the present invention.

FIGS. 8 to 13 are diagrams illustrating examples of memory systems, according to embodiments of the present invention.

### DETAILED DESCRIPTION

Although, various embodiments are described below in more detail with reference to the accompanying drawings, we note that the present invention may be embodied in different forms and should not be construed as being limited to the embodiments set forth herein. Rather, the described embodiments are provided so that this disclosure will be thorough and complete, and will fully convey the present invention to those skilled in the art to which this invention pertains. Throughout the disclosure like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context dearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

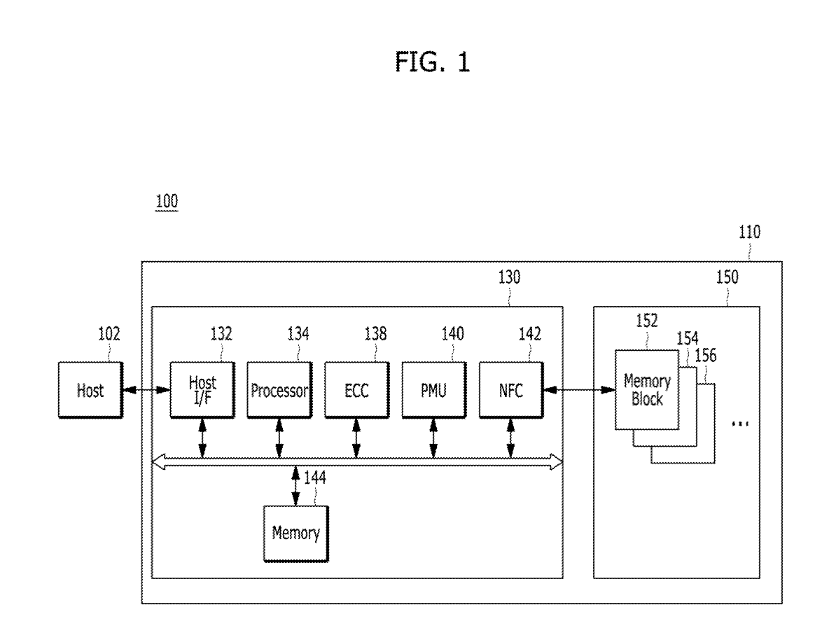

FIG 1 illustrates a data processing system 100 according to an embodiment of the present invention.

Referring to FIG. 1, the data processing system 100 may include a memory system 110 operatively coupled to a host 102.

The host 102 may be or include, for example, a portable electronic device such as a mobile phone, an MP3 player and a laptop computer or a non-portable electronic device such as a desktop computer, a game player, a television (TV) and a projector.

The memory system 110 may operate in response to a request from the host 102. For example, the memory system 110 may store data in response to a program request from the host. The stored data may be accessed by the host 102 in response to a read request. The memory system 110 may be used as a main memory or an auxiliary memory of the host 102. The memory system 110 may be implemented with any one of various storage devices, according to the protocol of a host interface to be coupled electrically with the host 102. The memory system 110 may be implemented with any one of various storage devices such as, for example, a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage devices forming the memory system 110 may be implemented with a volatile memory device, such as, a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase-change RAM (PRAM), a magneto-resistive RAM (MRAM), a resistive RAM (RRAM) and a flash memory.

The memory system 110 may include a memory device 150 and a controller 130. The memory device 150 stores data to be accessed by the host 102, and the controller 130 controls data exchange between the memory device 150 and the host 102. That is, under the control of the controller 130, data provided from the host 102 may be stored in the memory device 150 and data read from the memory device 150 may be provided to the host 102.

The controller 130 and the memory device 150 may be integrated into a semiconductor device. For instance, the controller 130 and the memory device 150 may be integrated into a semiconductor device to form a solid-state drive (SSD). When the memory system 110 is used as a SSD, the operation speed of the host 102 that is electrically coupled with the memory system 110 may be significantly increased.

The controller 130 and the memory device 150 may be integrated into a semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD an SDHC, and a universal flash storage (UFS) device.

For another instance, the memory system 110 may be configured as at least one part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage for a data center, a device capable of transmitting and receiving information under a wireless environment, one of various electronic devices for a home network, one of various electronic devices for a computer network, one of various electronic devices for a telematics network, an RFID device, or one of various component elements for a computing system.

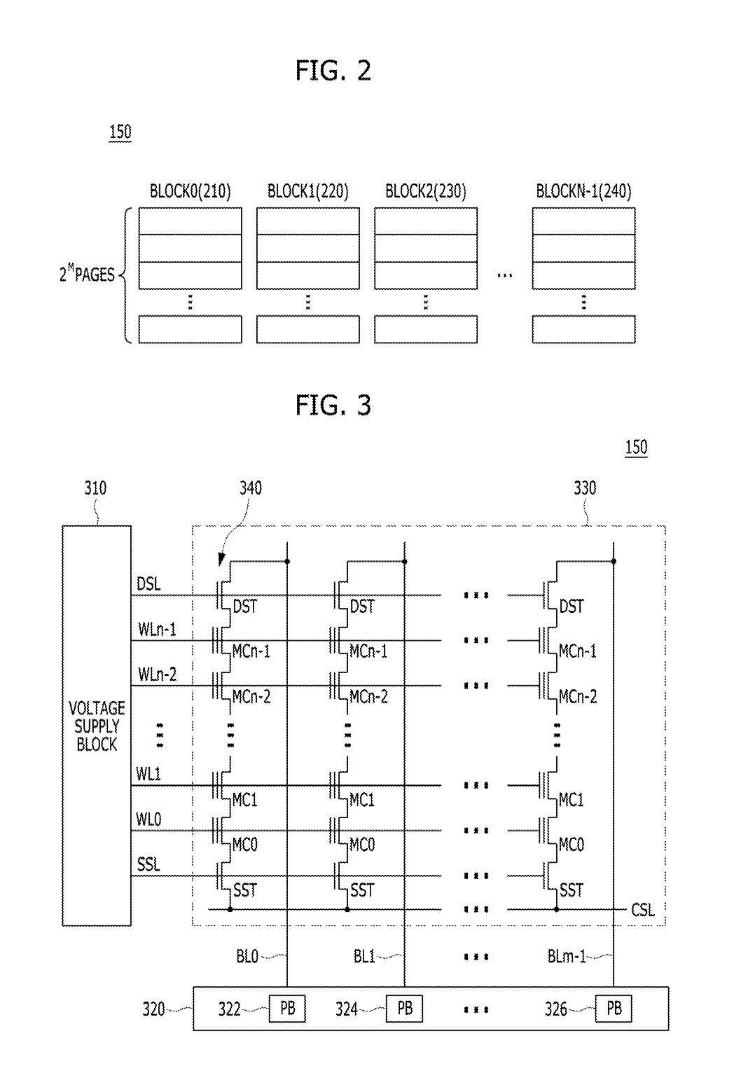

The memory device 150 may retain stored data even when power to the device is blocked. The memory device 150 may store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells. The memory cells of a page may be electrically coupled to the same word line (WL) The memory cells may be single bit cells or multi-bit cells. The memory cells may be arranged in a two-dimensional (2D) or a three-dimensional (3D) stacked structure. The memory device 150 may be a nonvolatile memory device, for example, a flash memory. The flash memory may have a 3D stack structure. The structure of the memory device 150 and the 3D stack structure of the memory device 150 will be described later in detail with reference to FIGS. 2 to 4.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control the operations of the memory device 150 such as read, write (also referred to as program operations) and erase operations. The controller 130 may be configured to determine a power level for an operation to be performed by the memory system in response to a command received from the host 102 and may provide the determined power level to a memory block which is subject to the operation. The controller 130 may determine the power level for an operation corresponding to a received command by checking at least one operation parameter of the operation. The operation parameter may be included in the received command. Alternatively, the operation parameter may be determined by the controller based on information included in the received command in conjunction with information stored in the working memory of the controller 130.

For example, the controller 130 may include a host interface (I/F) unit 132, a processor 134, an error correction code (ECC) unit 138, a power management unit (PMU) 140, a NAND flash controller (NFC) 142, and a memory 144.

The host interface unit 132 may process commands and data to and from the host 102. The host interface unit 132 may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of error bits. The ECC unit 138 may output an error correction fail signal indicating a failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130. The PMU 140 may provide one or more voltages of various power levels to the memory blocks of the memory device 150 as may be determined by the controller 130 for the various operations of the memory system.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory. It should be understood that the NFC 142 is just an example of a suitable memory interface for a NAND flash memory. Any other suitable memory interface between the controller 130 and the memory device 150 may be employed based on a particular embodiment depending upon the type of the memory device.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory such as a static random access memory (SRAM) or a dynamic random access memory (DRAM). As described above, the memory 144 may store data used by the host 102 and the memory device 150 for the read and write operations. For such storage of the data, the memory 144 may include a program memory, a data memory, a write buffer, a read buffer, a map buffer, and so forth.

The processor 134 may control the general operations of the memory system 110 and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

FIG. 2 is a detailed diagram of the memory device 150.

Referring to FIG. 2, the memory device 150 may include a plurality of memory blocks, for example, a zeroth memory block (BLOCK0) 210, a first memory block (BLOCK2) 220, a second memory block (BLOCK2) 230 and an N−1^{th} memory block (BLOCKN−1) 240. Each of the memory blocks 210 to 240 may include a plurality of pages, for example, 2^{M} number of pages (2^{M} PAGES) electrically coupled to a plurality of word lines. Each of the pages may include a plurality of memory cells.

Also, the memory device 150 may include a plurality of memory blocks, as single level cell (SLC) memory blocks and multi-level cell (MLC) memory blocks according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the memory blocks 210 to 240 may store the data provided from the host 102 during a write operation, and provide the stored data to the host 102 during a read operation.

FIG. 3 is a circuit diagram illustrating an exemplary configuration for one of the memory blocks 152 to 156 of the memory device 150 of FIG. 2. FIG. 3 shows a single memory block generally designated with numeral 330 which is operatively coupled to circuits 310 and 320.

Referring to FIG. 3, the memory block 330 may include a plurality of cell strings 340 which are electrically coupled to a plurality of bit lines BL0 to BLm−1, respectively. The cell string 340 of each column may include at least one drain select transistor DST (also referred to as string select transistor) and at least one source select transistor SST also referred to as a ground select transistor. A plurality of memory cell transistors MC0 to MCn−1 may be electrically coupled in series between the select transistors SST and DST. The respective memory cells MC0 to MCn−1 may be configured by multi-level cells (MLC) each of which stores data information of a plurality of bits. The cell strings 340 may be electrically coupled to the corresponding bit lines BL0 to BLm−1, respectively. For reference, in FIG. 3, ‘DSL’ denotes a drain select line (i.e., a string select line), ‘SSL’ denotes a source select line, and ‘CSL’ denotes a common source line.

While FIG. 3 shows, as an example, the memory block 330 which is configured by NAND flash memory cells, it is to be noted that the memory block 330 of the memory device 300 according to an exemplary embodiment of the present invention is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also to a charge trap flash (CTF) in which a charge storing layer is configured by a dielectric layer.

A voltage supply block 310 of the memory device 300 may provide word line voltages, for example, a program voltage, a read voltage and a pass voltage, to be supplied to respective word lines according to an operation mode and voltages to be supplied to bulks, for example, well regions, where the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 300 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines). A plurality of latches (not shown) may be included in each of the page buffers 322, 324 and 326.

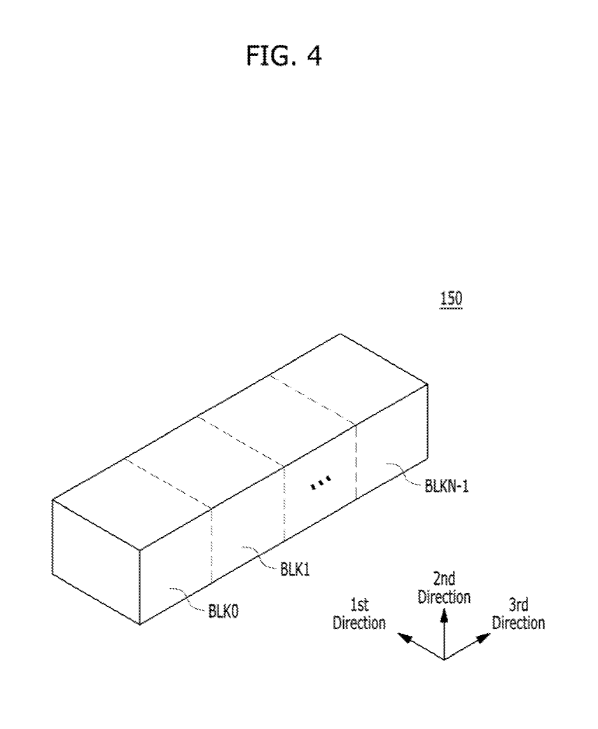

The memory device 150 may be realized as a 2D or 3D memory device. For example, as shown in FIG. 4, in the case where the memory device 150 is realized as a 3D nonvolatile memory device, the memory device 150 may include a plurality of memory blocks BLK0 to BLKN−1.

FIG. 4 is a schematic diagram illustrating the memory device 150 including memory blocks BLK0 to BLKN−1, and the memory blocks BLK0 to BLKN−1 may be realized as a 3D structure (or a vertical structure). For example, the respective memory blocks BLK0 to BLKN−1 may be realized as a 3D structure by including a structure which extends in first to third directions (for example, the x-axis direction, the y-axis direction and the z-axis direction).

The respective memory blocks BLK0 to BLKN−1 may include a plurality of NAND strings extending in the second direction. The plurality of NAND strings may be provided in the first direction and the third direction. Each NAND string may be electrically coupled to a bit line, at least one drain select line, at least one ground select line, a plurality of word lines, at least one dummy word line, and a common source line. Namely, the respective memory blocks BLK0 to BLKN−1 may be electrically coupled to a plurality of bit lines, a plurality of drain select lines, a plurality of ground select lines, a plurality of word lines, a plurality of dummy word lines, and a plurality of common source lines.

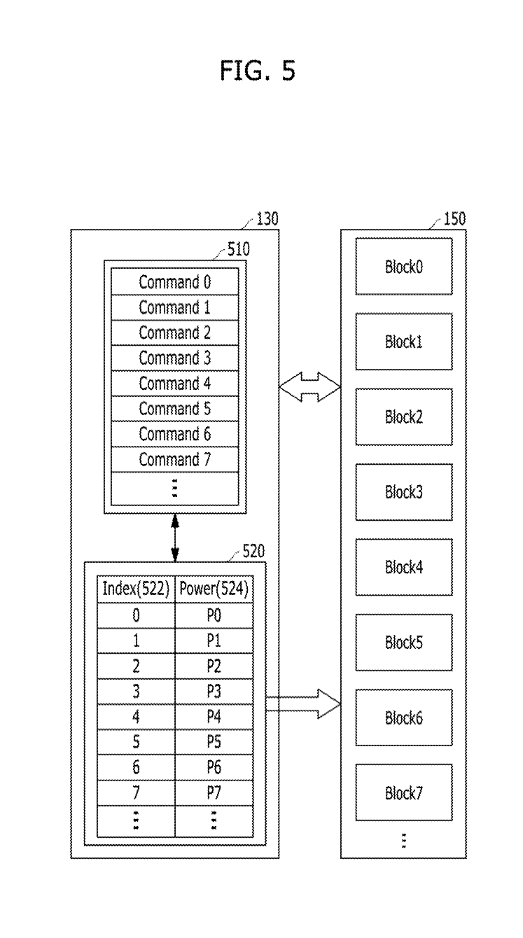

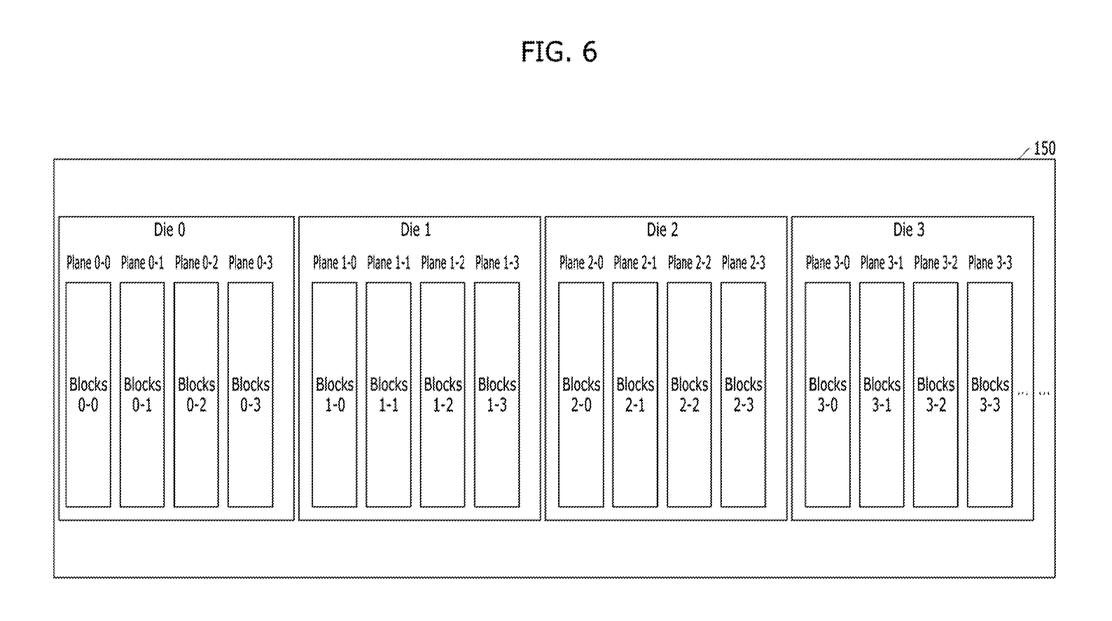

FIGS. 5 and 6 are schematic diagrams illustrating an example of a data processing operation of the memory system 110, according to an embodiment of the present invention.

Referring to FIG. 5, the controller 130 may further include a queuing unit 510 and a power supply unit 520 as well as the elements described with reference to FIG. 1. The queuing unit 510 may, for example, be a part of the memory 144 of the controller 130. The power supply unit 520 may be part of the PMU unit 140. The power supply unit 520 may be operatively coupled with the PMU unit 140. The memory device 150 may include first to eighth memory blocks Block0 to Block7, which correspond to the memory blocks 152 to 156 of FIG. 1.

In this regard, the controller 130 generates and updates information, e.g., first map data and second map data, indicating that the user data is stored in pages included in the memory blocks 552, 554, 562, 564, 572, 574, 582 and 584 of the memory device 150, in other words, generates and updates logical segments of the first map data, that is, L2P segments, and physical segments of the second map data, that is, P2L segments, and then performs a map flush operation and stores them in pages included in the memory blocks 552, 554, 562, 564, 572, 574, 582 and 584 of the memory device 150.

For instance, the controller 130 caches and buffers user data corresponding to a write command received from the host 102 in a buffer included in the memory 144 of the controller 130, that is, stores data segments of the user data in a data buffer/cache, and then writes and stores the data segments stored in the buffer/cache, in pages included in the memory blocks 552, 554, 562, 564, 572, 574, 582 and 584 of the memory device 150.

As the data segments of the user data corresponding to the write command received from the host 102 are written and stored in the pages of the memory blocks 552, 554, 562, 564, 572, 574, 582 and 584 of the memory device 150, the controller 130 generates first map data and second map data and stores them in a buffer included in the memory 144 of the controller 130, that is, stores L2P segments of the first map data and P2L segments of the second map data for the user data, in a map buffer/cache. In this regard, as described above, the L2P segments of the first map data and the P2L segments of the second map data may be stored in the map buffer/cache of the memory 144 of the controller 130, or a map list for the L2P segments of the first map data and a map list for the P2L segments of the second map data may be stored in the map buffer/cache. In addition, the controller 130 writes and stores the L2P segments of the first map data and the P2L segments of the second map data that have been stored in the map buffer/cache, in pages included in the memory blocks 552, 554, 562, 564, 572, 574, 582 and 584 of the memory device 150.

Furthermore, the controller 130 may perform a command operation corresponding to a command received from the host 102, for example, a program operation corresponding to a read command received from the host 102. In this case, the controller 130 loads map segments of user data corresponding to the read command received from the host 102, for example, L2P segments of the first map data and P2L segments of the second map data, on the map buffer/cache and checks the map segments, and thereafter reads user data stored in the pages included in associated memory blocks among the memory blocks 552, 554, 562, 564, 572, 574, 582 and 584 of the memory device 150, stores the read data segments of the user data in the data buffer/cache, and then provides the data segments to the host 102.

In addition, as described above, when performing an erase operation or the like or performing a background operation e.g., an operation of copying data from the memory blocks included in the memory device 150 or soaping the data, for example, a garbage collection operation or a wear leveling operation, the controller 130 stores data segments of corresponding user data in the data buffer/cache, and also stores meta segments of corresponding metadata, for example, map segments of map data in the map buffer/cache, and performs an erase operation, a data copy operation, a data swap operation or the like. Referring to FIG. 6, the memory device 150 may include a plurality of memory dies 0 to 3. The memory dies 0 to 3 may include a plurality of planes 0-0 to 3-3, respectively. The planes 0-0 to 3-3 may include a plurality of blocks 0-0 to 3-3, respectively. Each of the memory blocks 0-0 to 3-3 may be an SLC memory block, or an MLC memory block such as, for example, a TLC memory block. Referring to FIGS. 5 and 6, first to eighth memory blocks Block0 to Block7 of FIG. 5 may be included in the same or different planes of the same or different memory dies of FIG. 6.

In the present embodiment, the controller 130 may write or read user data and metadata in or from pages included in the memory blocks 0-0 to 3-3. For example, the controller 130 may group the memory blocks 0-0 to 3-3 into a plurality of super memory blocks, and then write and read the user data and metadata in or from the supper memory blocks through a one-shot program/one-shot read, a multi-plane program/multi-plane read, a one-plane program/one-plane read, or the like. A super memory block may include at least two memory blocks, preferably at least three memory blocks, and more preferably at least four memory blocks for improving the use efficiency of the memory device.

Each of the super memory blocks may include a plurality of memory blocks included in the same or different memory planes of the same or different memory dies.

In the present embodiment, although description for the case where the controller 130 performs a command operation corresponding to a command provided from the host 102 will be made as an example the like description may also be applied to the case where the controller 130 performs a background operation for the memory device 150, for example, the case where a data copy operation, a data swap operation or the like is performed in the memory blocks 0-0 to 3-3 of the memory device 150.

The controller 130 may queue the commands received from the host for one or more of the first to eighth memory blocks Block0 to Block7 in the queuing unit 510. The controller 130 may also check the queued commands in the queuing unit 510. It is exemplarily assumed that first to eighth commands 0 to 7 are queued in the queuing unit 510. It is also exemplarily assumed that the first to third commands 0 to 2 are write commands for the first to third memory blocks Block0 to Block2, the fourth to sixth commands 3 to 5 are read commands for the fourth to sixth memory blocks Block3 to Block5, and the seventh and eighth commands 6 and 7 are erase commands for the seventh and eighth memory blocks Block6 and Block7, respectively.

In an embodiment, the controller 130 checks at least one operation parameter of each of the queued commands. The operation parameter may indicate a type of operation corresponding to the respective queued commands. The type of operation may include a one-shot program/read, a multi-plane program/read, and a one-plane program/read. The operation parameter may indicate reliability and importance values of the operation. The operation parameter may indicate a priority, a size and/or a type of data subject to the operation. The priority of data may be determined according to an importance value of the data and reliability of process to the data. The type of the data includes characteristics, locality, processing pattern and processing latency of the data, and operation frequency, number of times or aging of operations for the data. For instance, the data may be classified, according to the type of the data, into metadata or user data, random data or sequential data, hot data or cold data, temporary data or shot term data or long term data, real-time data or non-real-time data, text data or audio data or image data or video data, operating system (OS) data or firmware data, and so forth. The operation parameter may indicate a type of memory block subject to the operation corresponding to the queued command. For example, the type of memory block may indicate one of the SLC, or the MLC memory block.

The controller 130 respectively may determine power levels for the operations corresponding to the commands queued in the queuing unit 510 according to a result of the checking step of the operation parameters. For example, the controller 130 may respectively determine first to third power levels P0 to P2 for the program operations corresponding to the first to third commands 0 to 2, which are the write commands for the first to third memory blocks Block0 to Block2. The first to third power levels P0 to P2 may become lower in the recited order, i.e., the level of P1 being lower than the level of P0 and the level of P2 being lower than the level of P1.

In an embodiment, the first command 0 may be for the one-shot program operation to program data of the highest priority into the first memory block Block0. Therefore, the controller 130 may determine the first level P0 or the greatest level for the one-shot program operation corresponding to the queued first command 0. The third command 2 may be for the one-plane program operation to program data of the lowest priority into the third memory block2. Therefore, the controller 130 may determine the third level P2 or the smallest level for the one-plane program operation corresponding to the queued third command 2.

In another embodiment the first memory block Block0 may be a TLC memory block while the third memory block Block2 may be an SLC memory block. Therefore, the controller 130 may determine the first level P0 or the greatest level for the program operation to the TLC memory block (i.e., the first memory block Block0) in response to the queued first command 0 while determining the third level P2 or the smallest level for the program operation to the SLC memory block (i.e., the third memory block Block2) in response to the queued third command 2.

By similar way, the controller 130 may respectively determine fourth to sixth power levels P3 to P5 for the read operations corresponding to the fourth to sixth commands 3 to 5, which are the read commands for the fourth to sixth memory blocks Block3 to Block5. The fourth to sixth power levels P3 to P5 may become lower in ascending order. The fourth to sixth power levels P3 to P5 may be lower than the first to third power levels P0 to P2.

Further, by similar way, the controller 130 may respectively determine seventh and eighth power levels P6 and P7 for the erase operations corresponding to the seventh and eighth commands 6 and 7, which are the erase commands for the seventh and eighth memory blocks Block6 to Block7. The seventh and eighth power levels P6 and P7 may become lower in ascending order. The seventh and eighth power levels P6 and P7 may be lower than the first to sixth power levels P0 to P5.

The check of the operation parameters and the determination of the power levels for the operations corresponding to the commands queued in the queuing unit 510 may also be applied to a background operation such as a data copy operation and a data swap operation. During the background operations to the memory blocks 552 to 584, the controller 130 may determine power levels for the background operations by checking the operation parameters of the background operations. For example, the controller 130 may check the type of the data copy operation or data swap operation to be performed in each of the memory blocks by checking whether it is a one-shot program/read, a multi-plane program/read, a one-plane program/read, or the like, and checks the reliability and importance value of the data copy operation or data swap operation, the priority, size and type of data corresponding to the data copy operation or data swap operation, and so forth.

As such, the controller 130 determines respective power levels for the operations of the queued commands and the background operations to the memory blocks of the memory device 150 by checking the operation parameters of the operations of the queued commands and the background operations, and thereafter provides the memory blocks with the determined level of powers 524 for the operations of the queued commands and for the background operations by indexes 522 of the memory blocks through the power supply unit 520. Thereby, the controller 130 may normally perform the command operations or background operations to the respective memory blocks 552 to 584. In this regard, the controller 130 may use the power supply unit 520 to provide powers having respective power levels to the corresponding memory blocks of the memory device 150, or alternatively use the power management unit 140 described with reference to FIG. 1 to provide powers having respective power levels to the corresponding memory blocks of the memory device 150.

That is, in the memory system in accordance with the present embodiment, optimal power levels can be provided for the operations to the respective memory blocks, whereby the command operations can be more reliably performed, and supply of power in the memory system is optimized, so that power consumption can be reduced.

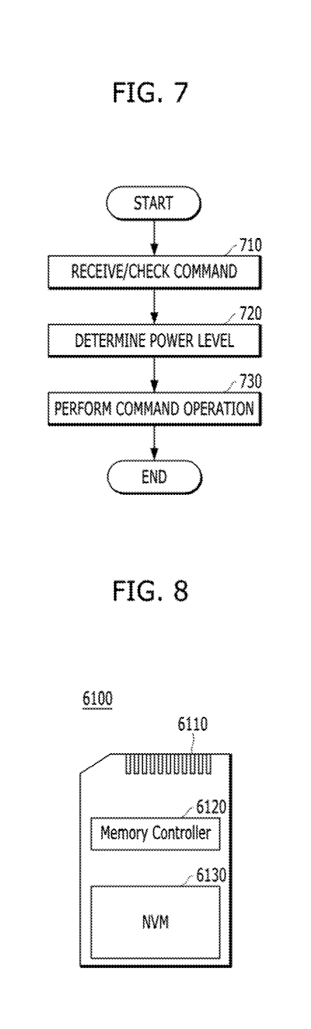

FIG. 7 is a flowchart illustrating the data processing operation of FIGS. 5 and 6.

Referring to FIG. 7, at step 710, the memory system 110 receives and checks commands provided from the host 102. Step 710 may include queuing the received commands in a queuing unit 510 as discussed with reference to FIG. 5. The memory system may then check the commands which includes checking the operation parameters of operations corresponding to the commands queued in the queuing unit 510 and background operations.

At step 720, the controller 130 may determine power levels for the operations of the queued commands and for the background operations according to a result of the check to their respective operation parameters. Power levels in the respective memory blocks may be determined such that the command operations in the memory blocks are normally performed. For example, the power levels in the respective memory blocks may be determined in correspondence with the types, of the command operations, the reliabilities and importance values of the command operations, and the priorities, sizes and types of data corresponding to the command operations, and so forth. In addition, each of the power levels may be determined in correspondence with a memory cell type of the corresponding memory block, for example, depending on whether it is a single-level cell memory block, a multi-level cell memory block, or a triple-level cell memory block.

At step 730, the controller 130 provides the memory blocks with the determined level of powers 524 for the operations of the queued commands and for the background operations by indexes 522 of the memory blocks through the power supply unit 520.

In this regard, the detailed descriptions for steps 710 to 730 have been provided with reference to FIGS. 5 and 6, therefore, further detailed description thereof will be omitted.

Hereinbelow, detailed descriptions will be made with reference to FIGS. 8 to 13, for a data processing system and electronic appliances employing the memory system 110 described above, according to various embodiments of the present invention.

FIG. 8 is a diagram illustrating a data processing system including the memory system 110, according to an embodiment. More specifically, FIG. 8 illustrates a memory card system to which the memory system 110 is applied.

Referring to FIG. 8, memory card system 6100 includes a memory controller 6120, a memory device 6130, and a connector 6110.

In detail, the memory controller 6120 may be connected with the memory device 6130 and may access the memory device 6130. In some embodiments, the memory device 6130 may be implemented with a nonvolatile memory (NVM). For example, the memory controller 6120 may control read, write, erase and background operations for the memory device 6130. The memory controller 6120 may provide an interface between the memory device 6130 and a host (not shown), and may drive a firmware for controlling the memory device 6130. For example, the memory controller 6120 may correspond to the controller 130 in the memory system 110 described above with reference to FIG. 1, and the memory device 6130 may correspond to the memory device 150 in the memory system 110 described above with reference to FIG. 1.

Therefore, the memory controller 6120 may include components such as a random access memory (RAM), a processing unit, a host interface, a memory interface and an error correction unit as shown in FIG. 1.

The memory controller 6120 may communicate with an external device (for example, the host 102 described above with reference to FIG. 1), through the connector 6110. For example, as described above with reference to FIG. 1, the memory controller 6120 may be configured to communicate with the external device through at least one of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (ESDI), Integrated Drive Electronics (IDE), Firewire, universal flash storage (UFS), wireless-fidelity (WI-FI) and Bluetooth. Accordingly, the memory system and the data processing system according to the embodiment may be applied to wired/wireless electronic appliances, For example, a mobile electronic appliance.

The memory device 6130 may be implemented with a nonvolatile memory. For example, the memory device 6130 may be implemented with various nonvolatile memory devices such as an electrically erasable and programmable ROM (EPROM), a NAND flash memory, a NOR flash memory, a phase-change RAM (PRAM), a resistive RAM (ReRAM), a ferroelectric RAM (FRAM) and a spin torque transfer magnetic RAM (STT-MRAM).

The memory controller 6120 and the memory device 6130 may be integrated into a single semiconductor device. For example, the memory controller 6120 and the memory device 6130 may construct a solid state driver (SSD) by being integrated into a single semiconductor device. The memory controller 6120 and the memory device 6130 may construct a memory card such as a PC card (PCMCIA: Personal Computer Memory Card International Association), a compact flash card (CF), a smart media card (SM and SMC), a memory stick, a multimedia card (MMC, RS-MMC, MMCmicro and eMMC), an SD card (e.g., SD, miniSD, microSD and SDHC) and a universal flash storage (UFS).

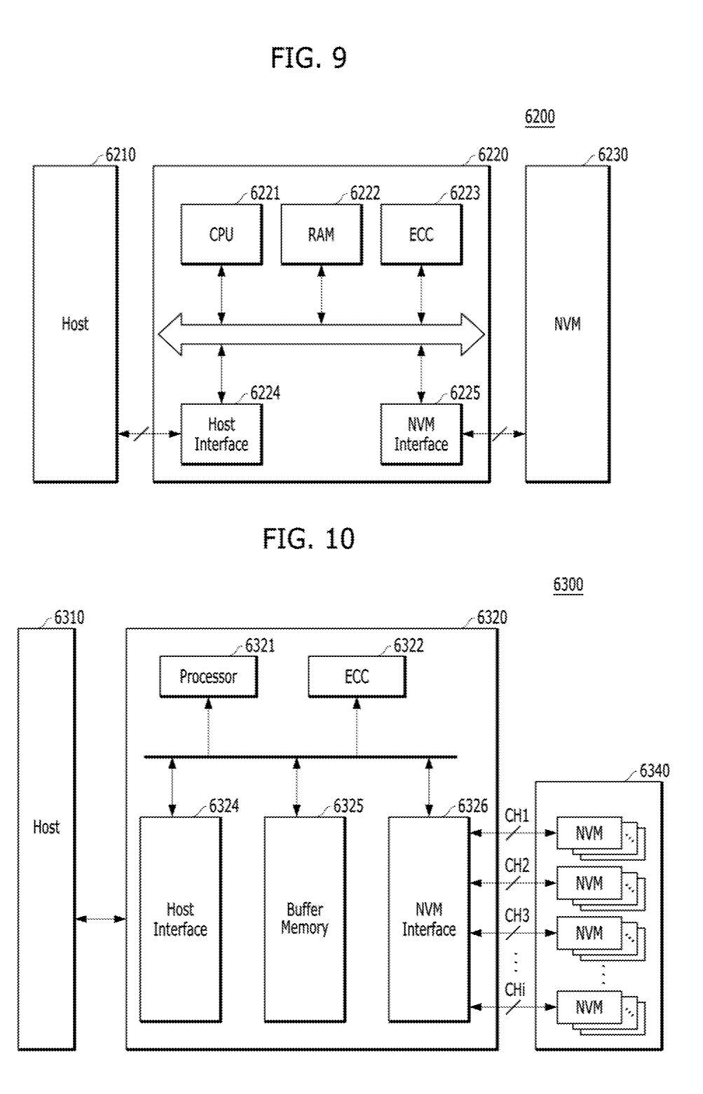

FIG. 9 is a diagram schematically illustrating a data processing system 6200 including a memory system, according to another embodiment of the present invention.

Referring to FIG. 9, a data processing system 6200 includes a memory device 6230 which may be implemented with at least one nonvolatile memory (NVM) and a memory controller 6220 for controlling the memory device 6230. The data processing system 6200 may be a storage medium such as a memory card (e.g., CF, SD and microSD), as described above with reference to FIG. 1. The memory device 6230 may correspond to the memory device 150 in the memory system 110 described above with reference to FIG. 1, and the memory controller 6220 may correspond to the controller 130 in the memory system 110 described above with reference to FIG. 1.

The memory controller 6220 may control the operations, including the read, write and erase operations for the memory device 6230 in response, to requests provided from a host 6210. The memory controller 6220 may include a central processing unit (CPU) 6221, a random access memory (RAM) as a buffer memory 6222, an error correction code (ECC) circuit 6223, a host interface 6224, and an NVM interface as a memory interface 6225, all coupled via an internal bus.

The CPU 6221 may control the operations for the memory device 6230 such as read, write, file system management, bad page management, and so forth. The RAM 6222 may operate according to control of the CPU 6221, and may be used as a work memory, a buffer memory, a cache memory, or the like. In the case where the RAM 6222 is used as a work memory, data processed by the CPU 6221 is temporarily stored in the RAM 6222. In the case where the RAM 6222 is used as a buffer memory, the RAM 6222 is used to buffer data to be transmitted from the host 6210 to the memory device 6230 or from the memory device 6230 to the host 6210. In the case where the RAM 6222 is used as a cache memory, the RAM 6222 may be used to enable the memory device 6230 with a low speed to operate at a high speed.

The ECC circuit 6223 corresponds to the ECC unit 138 of the controller 130 described above with reference to FIG. 1. As described above with reference to FIG. 1, the ECC circuit 6223 may generate an error correction code (ECC) for correcting a fail bit or an error bit in the data provided from the memory device 6230. The ECC circuit 6223 may perform error correction encoding for data to be provided to the memory device 6230, and may generate data added with parity bits. The parity bits may be stored in the memory device 6230. The ECC circuit 6223 may perform error correction decoding for data outputted from the memory device 6230. At this time the ECC circuit 6223 may correct errors by using the parity bits. For example, as described above with reference to FIG. 1, the ECC circuit 6223 may correct errors by using various coded modulations such as of a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM) and a Block coded modulation (BCM).

The memory controller 6220 transmits and receives data to and from the host 6210 through the host interface 6224, and transmits and receives data to and from the memory device 6230 through the NVM interface 6225. The host interface 6224 may be connected with the host 6210 through at least one of various interface protocols such as a parallel advanced technology attachment (PATA) bus, a serial advanced technology attachment (SATA) bus, a small computer system interface (SCSI), a universal serial bus (USB), a peripheral component interconnection express (PCIe) or a NAND interface. Further, as a wireless communication function or a mobile communication protocol such as wireless fidelity (WI-FI) or long term evolution (LTE) is realized, the memory controller 6220 may transmit and receive data by being connected with an external device such as the host 6210 or another external device other than the host 6210. Specifically, as the memory controller 6220 is configured to communicate with an external device through at least one among various communication protocols, the memory system and the data processing system according to the embodiment may be applied to wired/wireless electronic appliances, For example, a mobile electronic appliance.

FIG. 10 is a diagram illustrating a data processing system including the memory system 110, according to still another embodiment of the invention. FIG. 10 may be a solid-state drive (SSD).

Referring to FIG. 10, an SSD 6300 may include a memory device 6340 which may include a plurality of nonvolatile memories NVM and a controller 6320. The controller 6320 may correspond to the controller 130 in the memory system 110 described above with reference to FIG. 1, and the memory device 6340 may correspond to the memory device 150 in the memory system 110 described above with reference to FIG. 1.

In detail, the controller 6320 may be connected with the memory device 6340 through a plurality of channels CH1, CH2, CH3, . . . and CHi. The controller 6320 may include a processor 6321, a buffer memory 6325, an error correction code (ECC) circuit 6322, a host interface 6324, and a nonvolatile memory (NVM) interface as a memory interface 6326 coupled via an internal bus.

The buffer memory 6325 temporarily stores data provided from a host 6310 or data provided from a plurality of nonvolatile memories NVMs included in the memory device 6340, or temporarily stores metadata of the plurality of nonvolatile memories NVMs. For example, the metadata may include map data including mapping tables. The buffer memory 6325 may be implemented with a volatile memory such as, but not limited to, a dynamic random access memory (DRAM), a synchronous dynamic random access memory (SDRAM), a double data rate (DDR) SDRAM, a low power double data rate (LPDDR) SDRAM and a graphic random access memory (GRAM) or a nonvolatile memory such as, but not limited to, a ferroelectric random access memory (FRAM), a resistive random access memory (ReRAM), a spin-transfer torque magnetic random access memory (STT-MRAM) and a phase change random access memory (PRAM). While it is illustrated in FIG. 10, for the sake of convenience in explanation, that the buffer memory 6325 is disposed inside the controller 6320, it is to be noted that the buffer memory 6325 may be disposed outside the controller 6320.

The ECC circuit 6322 calculates error correction code values of data to be programmed in the memory device 6340 in a program operation, performs an error correction operation for data read from the memory device 6340, based on the error correction code values, in a read operation, and performs an error correction operation for data recovered from the memory device 6340 in a recovery operation for failed data.

The host interface 6324 provides an interface function with respect to an external device such as the host 6310. The nonvolatile memory interface 6326 provides an interface function with respect to the memory device 6340 which is connected through the plurality of channels CH1, CH2, CH3, . . . and CHi.

As a plurality of SSDs 6300 to each of which the memory system 110 described above with reference to FIG. 1 is applied are used, a data processing system such as a redundant array of independent disks (RAID) system may be implemented. In the RAID system, the plurality of SSDs 6300 and an RAID controller for controlling the plurality of SSDs 6300 may be included. In the case of performing a program operation by receiving a write command from the host 6310, the RAID controller may select at least one memory system (For example, at least one SSD 6300) in response to the RAID level information of the write command provided from the host 6310, among a plurality of RAID levels (for example, the plurality of SSDs 6300) and may output data corresponding to the write command, to the selected SSD 6300. In the case of performing a read operation by receiving a read command from the host 6310, the RAID controller may select at least one memory system (For example, at least one SSD 6300) in response to the RAID level information of the write command provided from the host 6310, among the plurality of RAID levels (for example, the plurality of SSDs 6300), and may provide data outputted from the selected SSD 6300, to the host 6310.

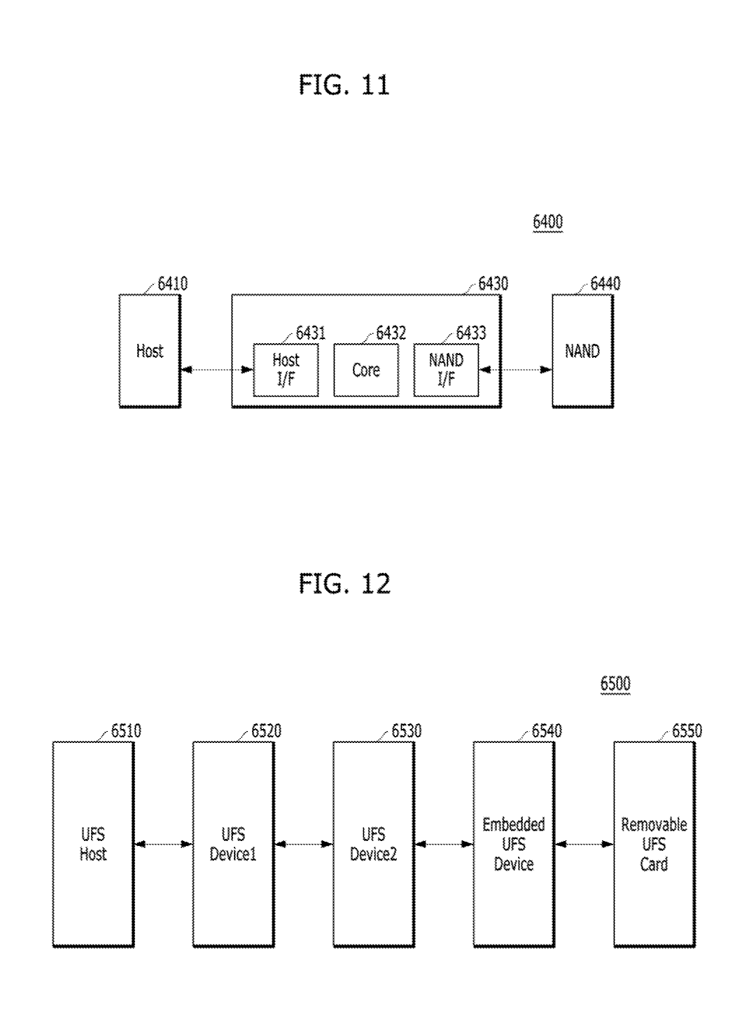

FIG. 11 is a diagram illustrating a data processing system including the memory system according to yet another embodiment of the present invention. FIG. 11 illustrates an embedded multimedia card (eMMC) to which the memory system 110 is applied.

Referring to FIG. 11, an eMMC 6400 includes a memory device 6440 which is implemented with at least one NAND flash memory, and a controller 6430. The controller 6430 may correspond to the controller 130 in the memory system 110 described above with reference to FIG. 1, and the memory device 6440 may correspond to the memory device 150 in the memory system 110 described above with reference to FIG. 1.

In detail, the controller 6430 may be connected with the memory device 6440 through a plurality of channels. The controller 6430 may include a core 6432, a host interface 6431, and a memory interface such as a NAND interface 6433.

The core 6432 may control the operations of the eMMC 6400. The host interface 6431 may provide an interface function between the controller 6430 and a host 6410. The NAND interface 6433 may provide an interface function between the memory device 6440 and the controller 6430. For example, the host interface 6431 may be a parallel interface such as an MMC interface, as described above with reference to FIG. 1, or a serial interface such as an ultra-high speed class 1 (UHS-I)/UHS class 2 (UHS-II) and a universal flash storage (UFS) interface.

FIG. 12 is a diagram illustrating a data processing system including a memory system according to yet another embodiment of the present invention. FIG. 11 illustrates a universal flash storage (UFS) to which the memory system 110 is applied.

Referring to FIG. 12, a UFS system 6500 may include a UFS host 6510, a plurality of UFS devices 6520 and 6530, an embedded UFS device 6540, and a removable UFS card 6550. The UFS host 6510 may be an application processor of wired/wireless electronic appliances, for example, a mobile electronic appliance.

The UFS host 6510, the UFS devices 6520 and 6530, the embedded UFS device 6540 and the removable UFS card 6550 may respectively communicate with external devices such as wired/wireless electronic appliances (for example, a mobile electronic appliance), through a UFS protocol. The UFS devices 6520 and 6530, the embedded UFS device 6540 and the removable UFS card 6550 may be implemented with the memory system 110 described above with reference to FIG. 1, for example, as the memory card system 6100 described above with reference to FIG. 8. The embedded UFS device 6540 and the removable UFS card 6550 may communicate through another protocol other than the UFS protocol. For example, the embedded UFS device 6540 and the removable UFS card 6550 may communicate through various card protocols such as, but not limited to, USB flash drives (UFDs), multimedia card (MMC), secure digital (SD), mini SD and Micro SD.

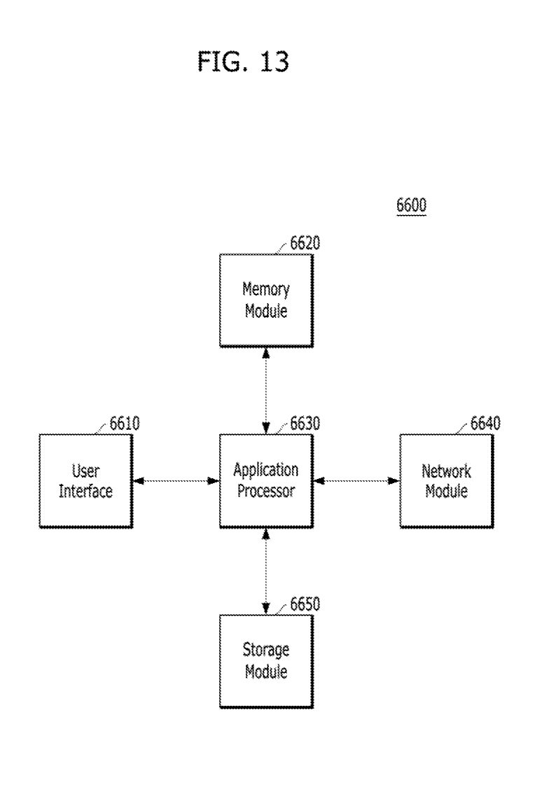

FIG. 13 is a diagram illustrating a data processing system including the memory system 110, according to yet another embodiment of the present invention. FIG. 13 illustrates a user system to which the memory system 110 is applied.

Referring to FIG. 13, a user system 6600 may include an application processor 6630, a memory module 6620, a network module 6640, a storage module 6650, and a user interface 6610.

The application processor 6630 may drive components included in the user system 6600 and an operating system (OS). For example, the application processor 6630 may include controllers for controlling the components included in the user system 6600, interfaces, graphics engines, and so on. The application processor 6630 may be provided by a system-on-chip (SoC).

The memory module 6620 may operate as a main memory, a working memory, a buffer memory or a cache memory of the user system 6600. The memory module 6620 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM and an LPDDR3 SDRAM or a nonvolatile random access memory such as a phase change random access memory (PRAM), a resistive random access memory (ReRAM), a magnetic random access memory (MRAM) and a ferroelectric random access memory (FRAM). For example, the application processor 6630 and the memory module 6620 may be mounted by being packaged on the basis of a package-on-package (POP).

The network module 6640 may communicate with external devices. For example, the network module 6640 may support not only wired communications but also various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), and so on, and may thereby communicate with wired/wireless electronic appliances, For example, a mobile electronic appliance. According to this fact, the memory system and the data processing system according to the embodiment may be applied to wired/wireless electronic appliances. The network module 6640 may be included in the application processor 6630.

The storage module 6650 may store data such as data provided from the application processor 6530, and transmit data stored therein, to the application processor 6530. The storage module 6650 may be realized by a nonvolatile semiconductor memory device such as a phase-change RAM (PRAM), a magnetic RAM (MRAM), a resistive RAM (ReRAM), a NAND flash memory, a NOR flash memory and a 3-dimensional NAND flash memory. The storage module 6650 may be provided as a removable storage medium such as a memory card of the user system 6600 and an external drive. For example, the storage module 6650 may correspond to the memory system 110 described above with reference to FIG. 1, and may be implemented with the SSD, eMMC and UFS described above with reference to FIGS. 10 to 12.

The user interface 6610 may include interfaces for inputting data or commands to the application processor 6630 or for outputting data to an external device. For example, the user interface 6610 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, a light emitting diode (LED), a speaker and a motor.

In the case where the memory system 110 described above with reference to FIG. 1 is applied to the mobile electronic appliance of the user system 6600 according to an embodiment, the application processor 6630 may control the operations of the mobile electronic appliance, and the network module 6640 as a communication module may control wired/wireless communication with an external device, as described above. The user interface 6610 as the display/touch module of the mobile electronic appliance displays data processed by the application processor 6630 or supports input of data from a touch panel.

In accordance with various embodiments of the present invention, a memory system is provided that exhibits reduced complexity and performance deterioration and which can improve the use efficiency of a memory device employed by the memory system. The memory system may rapidly and reliably process data to and from the memory device.

Although various embodiments have been described for illustrative purposes it will be apparent to those skilled in the art that various changes and modifications may be made without departing from the spirit and scope of the invention as defined in the following claims.

What is claimed is:

1. A memory system comprising:
a memory device including a plurality of memory blocks configured to store data; and
a controller configured to determine a power level for an operation corresponding to a command received from a host, and provide the determined power level to a memory block which is subject to the operation.

2. The memory system of claim 1, wherein the controller determines the power level for the operation corresponding to the command by checking at least one operation parameter of the operation included in the received command.

3. The memory system of claim 2, wherein the at least one operation parameter of the operation indicates whether the operation to be performed is a one-shot program/read, a multi-plane program/read, and a one-plane program/read.

4. The memory system of claim 2, wherein the at least one operation parameter of the operation indicates at least one of a reliability value and an importance value of the operation.

5. The memory system of claim 2, wherein the at least one operation parameter of the operation indicates at least one of a priority, a size and a type of data subject to the operation.

6. The memory system of claim 5, wherein the priority of the data is determined according to an importance value of the data and a reliability of process to the data.

7. The memory system of claim 5, wherein the type of the data includes at least one of:
i) a metadata or user data,
ii) a random data or sequential data,
iii) a hot data or cold data,
iv) a temporary data or short term data or long term data,
v) a real-time data or a non-real-time data,
vi) a text data or audio data or image data or video data, and
vii) an operating system (OS) data or a firmware data.

8. The memory system of claim 1, wherein the at least one operation parameter of the operation indicates at least one of a single level cell memory block, and a multiple level cell memory block,

9. The memory system of claim 1, wherein the controller further determines the power level for a background operation at least including a data copy operation and a data swap operation.

10. The memory system of claim 9,
wherein the controller determines the power level or the background operation by checking an operation parameter of the background operation, and
wherein the operation parameter of the background operation indicates at least one of:
i) a one-shot program/read, a multi-plane program/read, and a one-plane program/read;
ii) reliability and importance values of the background operation; and
iii) a priority, a size and a type of data subject to the background operation.

11. An operating method of a memory system including a plurality of memory blocks, the operating method comprising:
receiving a command from a host;
determining a power level for an operation corresponding to the command; and
providing the determined power level to one of the memory blocks subject to the operation.

12. The operating method of claim 11, wherein the power level for the operation corresponding to the command is determined by checking an operation parameter of the operation.

13. The operating method of claim 12, wherein the operation parameter of the operation indicates at least one of a one-shot program/read, a multi-plane program/read, and a one-plane program/read.

14. The operating method of claim 12, wherein the operation parameter of the operation indicates at least one of a reliability and an importance value of the operation.

15. The operating method of claim 12, wherein the operation parameters of the operation indicates at least one of a priority, a size and a type of data subject to the operation.

16. The operating method of claim 15, wherein the priority of the data is determined according to the importance value of the data and reliability of process to the data.

17. The operating method of claim 15, wherein the type of the data includes at least one of:
i) metadata or user data,
ii) random data or sequential data,
iii) hot data or cold data,
iv) temporary data or short term data or long term data,
v) real-time data or non-real-time data,
vi) text data or audio data,
viii) image data or video data and
ix) operating system (OS) data or firmware data.

18. The operating method of claim 11, wherein the operation parameter of the operation indicates at least one of a single level cell memory block, and a multiple level cell memory block.

19. The operating method of claim 11, further comprising determining the power level for a background operation at least including a data copy operation and a data swap operation.

20. The operating method of claim 19,
wherein the power level for the background operation is determined by checking an operation parameter of the background operation, and
wherein the operation parameter of the background operation indicates at least one of:
i) a one-shot program read, a multi-plane program/read, and a one-plane program/read;
ii) reliability and importance values of the background operation, and
iii) a priority, a size and a type of data subject to the background operation.
